(19) United States
(12) Patent Application Publication
(10) Pub. No.: US 2004/0045461 A1
(43) Pub. Date: Mar. 11, 2004

(54) Fingerprint art using fingerprint-ready image templates

(76) Inventor: Heather Thompson Shade, San Antonio, TX (US)

Correspondence Address: Heather Shade, 1813 Parhaven Dr., San Antonio, TX, 78232, US

(21) Appl. No.: 10/237,779

(22) Filed: Sep. 9, 2002

(51) Int. Cl. B41K 1/00; B41K 1/38

(52) U.S. Cl. 101/327; 101/333

(57) ABSTRACT

Fingerprint-ready image templates are used to facilitate the creation of fingerprint art. An image template is formed by a fingerprint-ready image including within it at least one fingerprint-sized area—a completed image is formed by inserting a fingerprint into the fingerprint-sized area, and if desired, coloring the image or drawing a scene around the image. In one technique, the image template is formed on a stamping implement (such as for use with an inkpad), which is used to stamp the image template onto paper in preparation for fingerprint insertion. In another technique, an entire scene is produced including one or more fingerprint-ready image template(s).

### BACKGROUND OF THE INVENTION

1. Field of the Invention

The invention relates to arts and crafts materials, and more particularly, to materials or implements for fingerprint art.

2. Description of Related Art

Without limiting the scope of the invention which is determined solely by the claims, this background information is provided in the context of a specific problem to which the invention in one of its aspects was directed: facilitating the creation of fingerprint art.

Fingerprint art is a popular arts and crafts activity for children. The child places a fingerprint on a piece of paper or other material, and then the child or someone else draws a picture that includes the fingerprint—typically the fingerprint is the body of a figure that is completed with hair, facial features, arms and legs, clothing, etc.

A number of books are available describing various step-by-step techniques for turning a fingerprint into a completed image. One popular such book is “Ed Emberley's Great Thumbprint Drawing Book” (Pub. Scholastic Paperbacks 1986 ISBN 0590326503, and later editions) by Edward Emberly. The author describes how to draw a figure or image using a fingerprint as the focal point of the figure or image.

A problem with current approaches to fingerprint art is the artistic effort needed to complete the image or scene that includes the fingerprint. On occasion, the child or family would prefer to have a fingerprint image or scene that is beyond the current artistic capabilities of the child, such as to illustrate to the child various techniques that can be used by the child to create fingerprint art.

### SUMMARY OF THE INVENTION

An object of the invention is to provide an implement that facilitates fingerprint art.

The invention is a fingerprint-ready image template. In one aspect, the invention includes an image template defining a fingerprint-ready image, with at least one fingerprint-sized area being defined within the fingerprint-ready image. The fingerprint-ready image is configured to be at least substantially completed by inserting a fingerprint into the fingerprint-sized area.

In an exemplary embodiment, the image template is formed on a stamping implement (such as for use with an inkpad), which is adapted to transfer the fingerprint-ready image template onto paper (or another image surface). Thus, an exemplary method of forming an image is to (a) form (such as by stamping) a fingerprint-ready image that includes at least one fingerprint-sized area within the fingerprint-ready image, and then (b) at least substantially complete the image by inserting a fingerprint into the fingerprint-sized area of the fingerprint-ready image.

In an alternate embodiment, one or more image templates are included within a scene.

A better understanding of the features and advantages of the invention will be obtained by reference to the following Detailed Description and accompanying Drawings that set forth an illustrative embodiment based on the principles of the invention.

### BRIEF DESCRIPTION OF THE DRAWINGS

FIGS. 1a and 1b illustrate respectively (1a) an exemplary image template defining a fingerprint-ready image prior to fingerprint insertion, and (1b) the same exemplary image template after a fingerprint has been inserted into the fingerprint-ready image, in accordance with one aspect of the invention.

FIGS. 2a-2d illustrate exemplary image templates after fingerprint insertion.

FIG. 3 illustrates an exemplary scene that includes multiple fingerprint-ready images prior to fingerprint insertion, in accordance with one aspect of the invention.

FIGS. 4a-4d illustrate an exemplary method of using a stamp to form an image template, in accordance with one aspect of the invention.

### DESCRIPTION OF AN EXEMPLARY EMBODIMENT

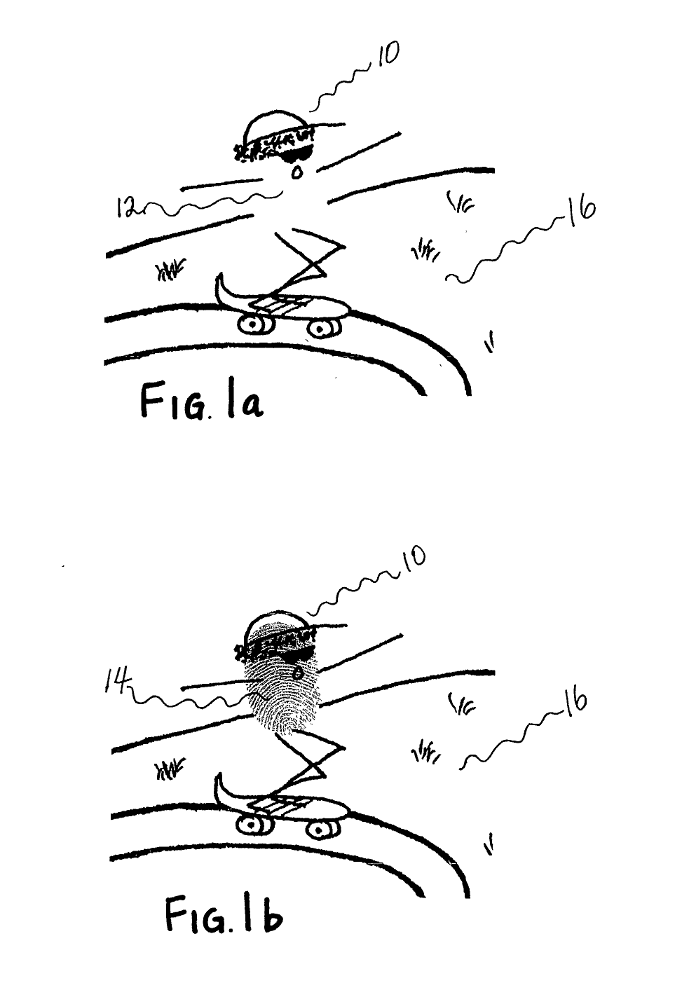

FIGS. 1a and 1b illustrate an exemplary embodiment of the principles of the invention.

FIG. 1a illustrates an image template in which an exemplary fingerprint-ready image 10 includes a fingerprint-sized area 12. In FIG. 1b, a fingerprint 14 has been inserted into the fingerprint-sized area (12 in FIG. 1a).

Insertion of the fingerprint 14 substantially completes an image of a figure on a skateboard comprising the fingerprint-ready image 10 and the fingerprint 14. This image can be further enhanced by coloring at least portions of the image, and/or adding additional lines to the image, and/or forming a scene 16 which includes the image.

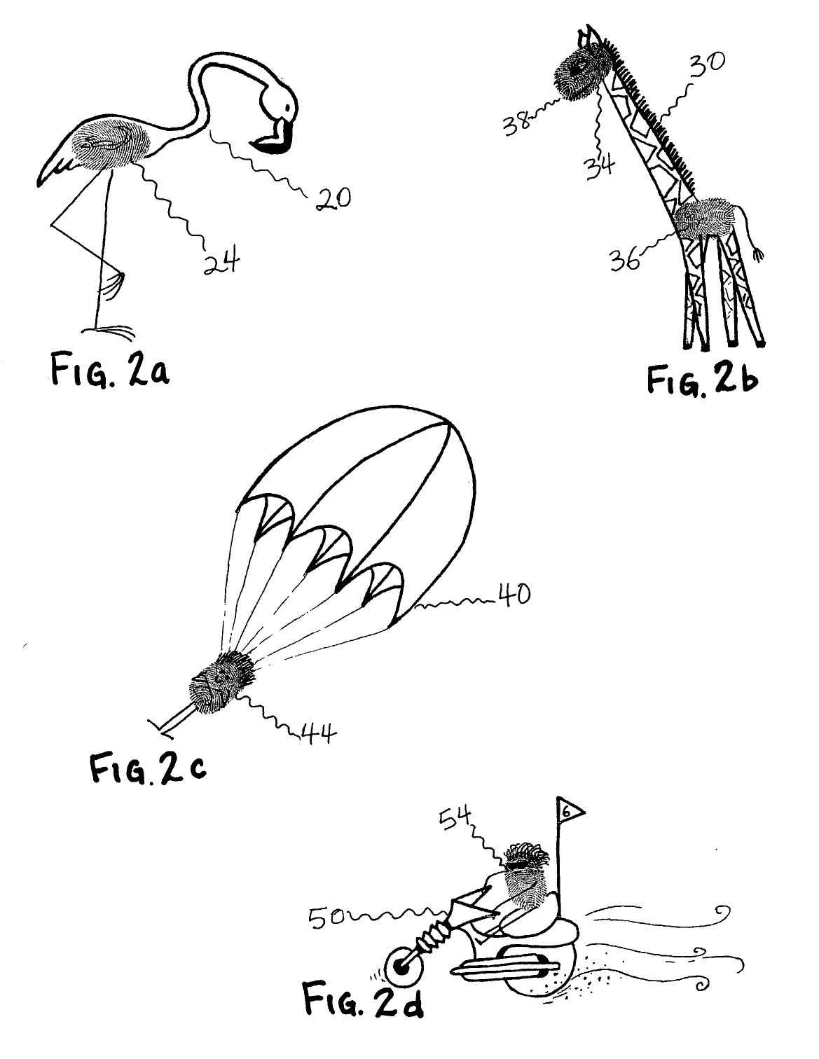

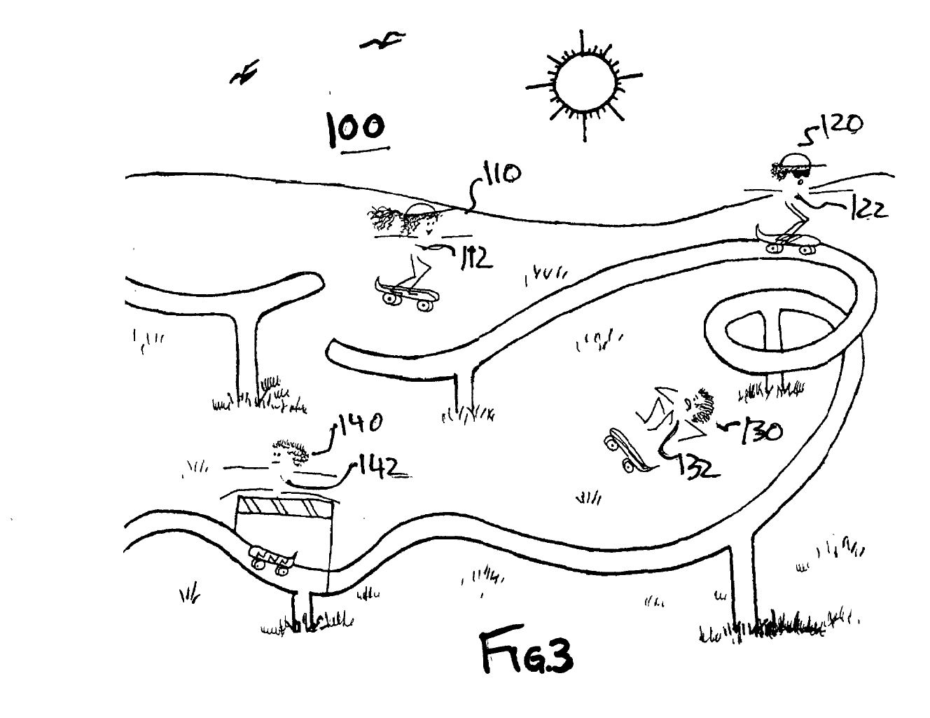

FIGS. 2a-2d illustrate various exemplary image templates after fingerprint insertion. FIG. 2a illustrates an image formed by an image template of a bird 20 and an inserted fingerprint 24. FIG. 2b illustrates an image formed by an image template of a giraffe 30 and two inserted fingerprints 34 and 36, where lines 38 have been added to form a nose and mouth. FIG. 2c illustrates an image formed by an image template of a figure with a parachute 40 and an inserted fingerprint 44. FIG. 2d illustrates an image formed by an image template of a figure on a motorcycle 50 and an inserted fingerprint 54.

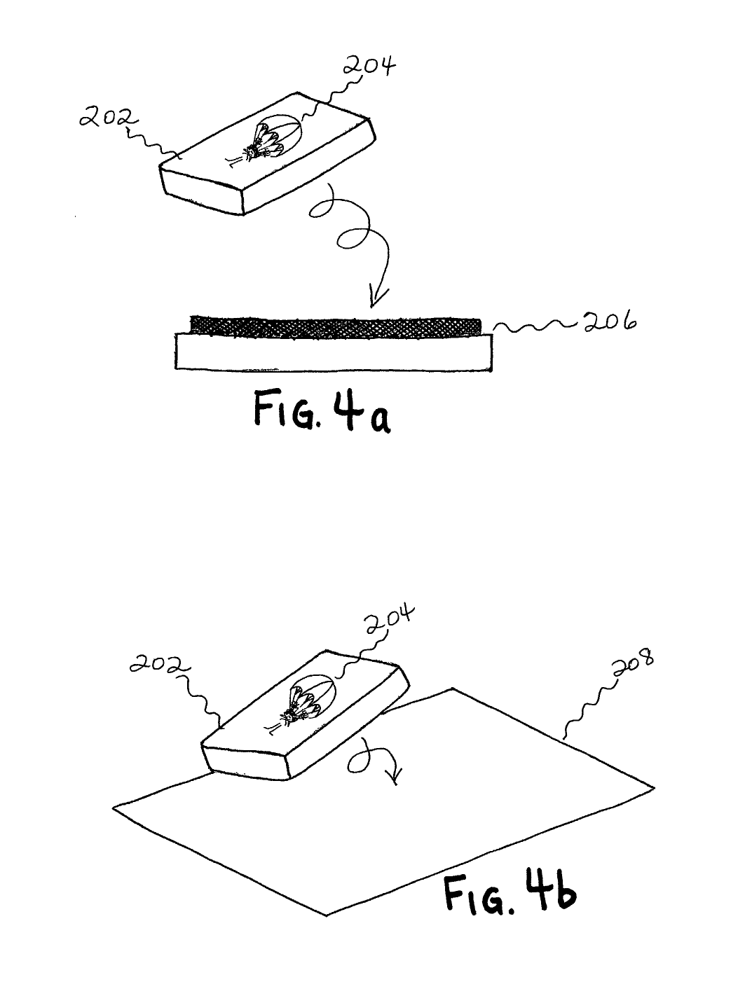

FIG. 3 illustrates an exemplary scene 100 that includes multiple fingerprint-ready image templates prior to fingerprint insertion. Specifically, the scene 100 includes image templates 110, 120, 130, and 140 of various skateboarding figures, respectively including fingerprint-sized areas 112, 122, 132, and 142. Thus, one or more image templates according to the invention can be included on a sheet with a pre-drawn scene.

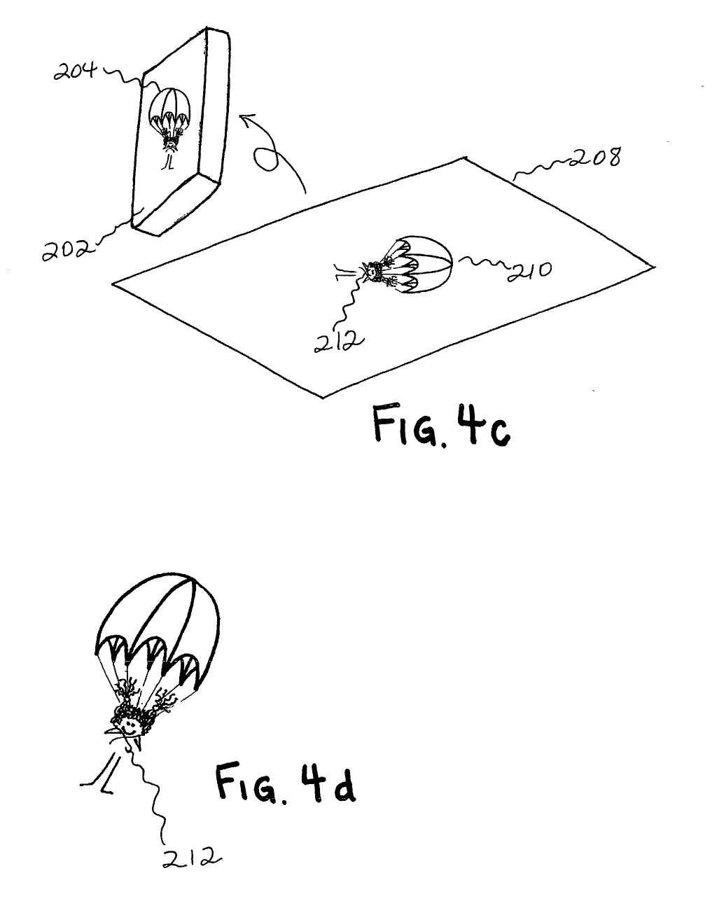

FIGS. 4a-4d illustrate an exemplary method of using a stamp to form an image template. Specifically, FIG. 4a illustrates a stamp 202 with a fingerprint-ready image template 204 and an inkpad 206. The stamp 202 is put into contact with the inkpad 206, transferring ink to the image template 204.

In FIGS. 4b and 4c, the inked stamp 204 contacts a piece of paper (or other image surface) 208, forming an image template 210 on the paper 208. The image template 210 includes a fingerprint-area 212, as shown more clearly in FIG. 4d.

The foregoing describes exemplary embodiments of the invention—various modifications of these embodiments, as well as various alternative embodiments of the invention, will be suggested to those skilled in the art. Thus, it is intended that the claims define the scope of the invention, and that the claims cover all structures and methods, and their equivalents, encompassed by the claims.

What is claimed is:

1. A fingerprint-ready image template, comprising:
(a) an image template defining a fingerprint-ready image; and
(b) at least one fingerprint-sized area being defined within the fingerprint-ready image;
(c) the fingerprint-ready image being configured to be at least substantially completed by inserting a fingerprint into the fingerprint-sized area.

2. The fingerprint-ready image-template of claim 1, wherein the image template is formed on a stamping implement adapted to transfer the fingerprint-ready image template onto an image surface.

3. The fingerprint-ready image-template of claim 1, further comprising a scene that includes one or more image templates.

4. A method of creating an image incorporating a fingerprint, comprising the steps:
(a) forming a fingerprint-ready image that includes at least one fingerprint-sized area within the fingerprint-ready image;
(b) at least substantially completing the image by inserting a fingerprint into the fingerprint-sized area of the fingerprint-ready image.

5. The method of creating an image incorporating a fingerprint of claim 4, wherein the fingerprint-ready image is formed on a stamping implement, and the step of forming a fingerprint-ready image is accomplished by stamping the fingerprint-ready image onto an image surface.

6. The method of creating an image incorporating a fingerprint of claim 4, further comprising the step of:
(a) forming a scene with at least one fingerprint-ready image that includes at least one fingerprint-sized area.
